(19) United States
(12) Patent Application Publication
(10) Pub. No.: US 2014/0218350 A1
(43) Pub. Date: Aug. 7, 2014

(54) POWER MANAGEMENT OF DISPLAY CONTROLLER

(71) Applicants: Kevin Guan Ming Wee, Pulau Pinang (MY); Chin Seng Lu, Bayan Lepas (MY); Pei Jin Lim, Gelugor (MY); Lee Teck Henry Lim, Bayan Lepas (MY)

(72) Inventors: Kevin Guan Ming Wee, Pulau Pinang (MY); Chin Seng Lu, Bayan Lepas (MY); Pei Jin Lim, Gelugor (MY); Lee Teck Henry Lim, Bayan Lepas (MY)

(21) Appl. No.: 14/126,799

(22) PCT Filed: Dec. 13, 2012
(86) PCT No.: PCT/US2012/069521

§ 371 Date: Dec. 16, 2013

(30) Foreign Application Priority Data
Dec. 16, 2011 (MY) PI 2011006135

(51) Int. Cl. G09G 3/20

(52) U.S. Cl. CPC G09G 3/20; G09G 2330/022
USPC 345/212

(57) ABSTRACT

In general, in one aspect, a display controller has non-essential portions powered off for a portion of vertical blanking interval (VBI) periods to conserve power. The portion takes into account overhead for housekeeping functions and memory latency for receiving a first packet of pixels for a frame to be decoded during a next active period. Gating circuitry may gate power to the non-essential portions starting at beginning of the VBI periods. A latency predictor may predict the portion of the VBI periods by predicting the memory latency for a next VBI period and subtracting the predicted memory latency from the VBI period. The memory latency for the next VBI period may be predicted by adding an average difference between successive actual memory latencies for a plurality of VBI periods to an actual memory latency for previous VBI period. A constant delay may also be subtracted from the VBI period.

### BACKGROUND OF THE INVENTION

Panel displays, such as liquid crystal displays (LCD), digital light processing (DLP) displays, and plasma displays, are utilized in many systems and platforms. Panel displays include a plurality of discrete pixels that provide the resolution of the display (e.g., 320×240, 640×480, 800×600, 1024×768). An image (frame) is written to the display pixel by pixel. The pixels are written at a rate that is fast enough that the human eye does not detect the pixel by pixel changes (pixel clock). After an image is written to the display there will be a waiting period, vertical blanking interval (VBI), before the next image is written over the current image. A backlight is utilized to illuminate the images written on the display so that they can be viewed.

A display controller fetches pixel data for a frame from memory and decodes the pixel data to determine output pixel values for the display and sends these values to the display. The display controller is on all of the time. During the VBI, the display controller is not actively processing pixels (is idle). The VBI may be a large percentage of the time depending on the display resolution, the refresh rate of the display (e.g., 60 Hz, 120 Hz) and the pixel clock (e.g., 25 MHz, 100 MHz). Accordingly, a large percentage of the time the display controller may be powered even though it is idle. Such an arrangement unnecessarily consumes excess power.

Power efficiency is becoming increasingly important especially in embedded systems, such as mobile Internet delivery (MID) and in-vehicle infotainment (IVI). These systems utilize a battery to provide power so excess power usage unnecessarily drains the battery and reduces battery life and accordingly operational time of the device.

### BRIEF DESCRIPTION OF THE DRAWINGS

The features and advantages of the various embodiments will become apparent from the following detailed description in which:

FIG. 1 illustrates a high level block diagram of a system to visually present content to a user;

FIG. 2 illustrates an example timing diagram of operations of a display controller;

FIG. 3 illustrates several example timing diagrams of the display controller being. powered off for a defined portion of a VBI, according to one embodiment

FIG. 4A illustrates an example functional block diagram of a system for controlling the power state of a display controller, according to one embodiment;

FIG. 4B illustrates an example functional block diagram of a display controller capable of powering down during inactive periods, according to one embodiment;

FIG. 5 illustrates an example high level flowchart for predicting the memory latency, according to one embodiment;

FIG. 6 illustrates an example memory latency predictor device, according to one embodiment;

FIG. 7 illustrates several example timing diagrams of the display controller being powered off for a defined portion of the VBI based on the predicted memory latency, according to one embodiment;

FIG. 8 illustrates an example content display system, according to one embodiment; and

FIG. 9 illustrates an example small form factor device in which the system of FIG. 8 may be embodied, according to one embodiment.

### DETAILED DESCRIPTION

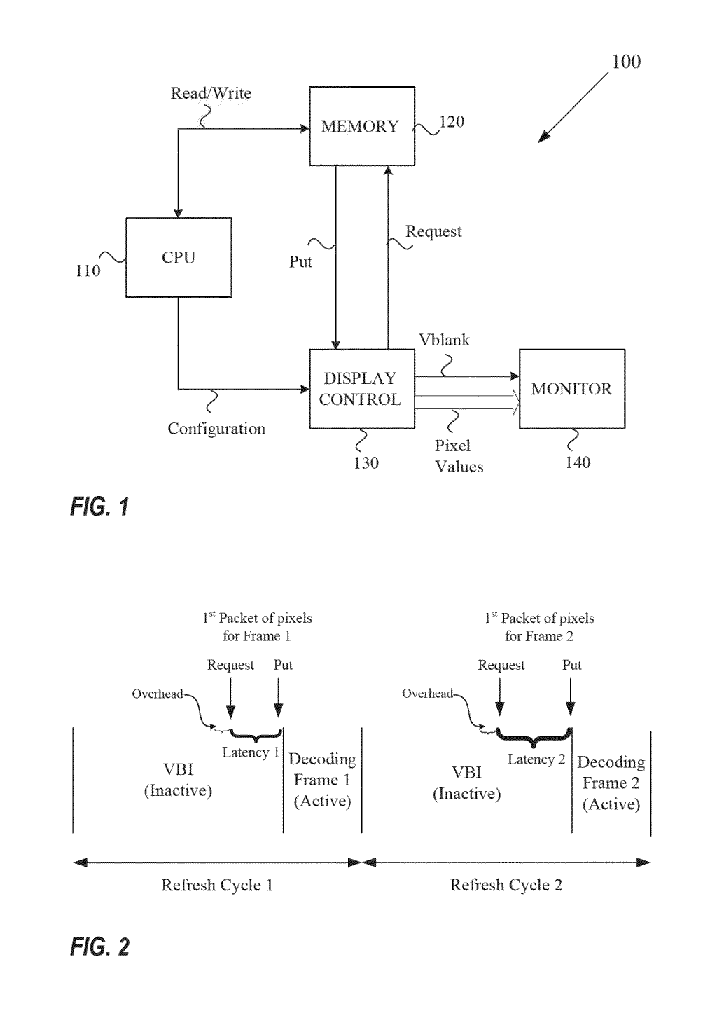

FIG. 1 illustrates a high level block diagram of a system 100 to visually present content to a user. The system 100 includes a processor (CPU) 110, memory 120, a display controller 130, and a monitor (panel display) 140. The CPU 110 controls the operations of the system 100. The CPU 110 may execute applications that generate an output for display and/or may process content (e.g., video, pictures) to be displayed. The CPU 110 reads and writes data to the memory 120. The data written to the memory 120 may include information related to content to be displayed on the monitor 140. The memory 120 may include a frame buffer (not separately illustrated) for storing the content to be displayed on the monitor 140.

The display controller 130 controls the writing of the content on the monitor 140. The display controller 130 may be configured by the CPU 110 based on the content to be displayed. The display controller 130 fetches pixel data for the content to be displayed from the memory 120. The fetch process may include the display controller 130 requesting pixel data from the memory 120 and the memory 120 outputting the requested pixel data to the display controller 130. The display controller 130 decodes the pixel data to determine output pixel values for the monitor 140 and transmits the pixel values to the monitor 140. Once the display controller 130 has transmitted all the pixel values for a current frame and is entering a vertical blanking interval (VBI) it may notify the monitor 140 of such. The notification provided by the display controller 130 may be the transmission of a message or activation of a signal (vblank). The notification informs the monitor 140 that the current frame has ended. Accordingly, the monitor 140 will know that the next pixel values received are for a new frame and processing of them should start at the first pixel of the first line of the monitor 140.

The system 100 may he an embedded system where the monitor 140 is incorporated therein. In an embedded system, the CPU 110, the memory 120, and the display controller 130 may be separate components or may be functional blocks of a system on a chip (SoC). The CPU 110, the memory 120, and the display controller 130 may be part of a computing platform and the monitor 140 may be an external component connected thereto. The display controller 130 may be an integral part of a graphics processor (not illustrated). The system 100 is in no way limited by these examples.

FIG. 2 illustrates an example timing diagram of operations of a display controller (e.g., 130 of FIG. 1). The timing diagram illustrates two refresh cycles. Each refresh cycle includes a VBI period that is substantially inactive and an active period in which the actual pixels for a frame are transmitted from the display controller to the monitor. During the active period the display controller decodes pixel data from memory into actual pixel values to be displayed by the monitor. The next VBI period following an active period is when the image on the monitor is static and waiting for the next refresh. The time associated with a refresh cycle is based on the refresh rate of the display (e.g., 60 Hz, 120 Hz). The active period of the refresh cycle is based on the resolution of the display (e.g., 640×480 pixels, 1024×768 pixels) and the pixel clock (e.g., 25 MHz, 100 MHz) with the VBI being the remaining portion. The display controller may be substantially inactive a relatively large percentage of the time (VBI illustrated as being approximately 70% of the refresh cycle).

In order to conserve power, non-essential portions of the display controller could be powered off during the VBI period. The display controller may include registers that maintain configuration data related to, for example, resolution of the display and base memory address where content is stored (configuration registers). This configuration data may be set during, for example, boot-up, mode changes, or application start-up, and typically does not change during normal usage. Accordingly, the configuration registers are an essential portion of the display controller and would need to remain powered during any power off of the display controller during the VBI. The display controller could use the vblank notification sent to the monitor to initiate the power off For example, the vblank notification could be provided to logic that gates the clock or power being provided to the display controller. The logic could turn the display controller on so that it's ready for its next active period (decoding).

In order for the display controller to be ready for the next active period it needs to do some housekeeping functions including, for example, memory address calculations to determine where to fetch the next frame from and resetting counters (c.a., pixel counters. line counters). The overhead associated with the housekeeping functions should be relatively low (small portion of the VBI) and should be consistent. Furthermore, in order to be able to decode the pixel data for a frame at the start of the active period the display controller must receive a first portion of the pixel data associated with the frame at, or prior to, the initiation of the active period. The first portion of the pixel data is based on buffer size of the display controller (not practical to have a buffer hold all of the pixels for a frame). In order for the first portion of the pixel data for a frame (first packet of pixels) to be received in time, the display controller needs to fetch the first packet of pixels during the VBI portion of the refresh cycle.

Accordingly, the display controller can only be powered off for a portion of the VBI (not the entire VBI). The display controller must be powered on during the VBI so that there is sufficient time for the housekeeping functions and to fetch the first packet of pixels. That is, the housekeeping overhead and the memory latency (the time between the request for the first packet of pixels from memory and the put of the first packet of pixels from memory) must be taken into account when determining the portion of the VBI that the display controller can be powered off. The memory latency may vary based on any number of parameters so there is no fixed amount of time that can be utilized accurately. While the memory latency may vary it is not likely it will vary drastically on a frequent basis.

Assuming a relatively large fixed memory latency (e.g., an estimated maximum memory latency) may reduce the amount of time the display controller is powered off during the VBI's. While this may ensure the first packet of pixels is available for the active period, it may result in the display controller being powered on sooner than required and thus not optimizing the power savings for many VBI's. Assuming a relatively small fixed memory latency may increase the amount of time the display controller is powered off during the VBI's. While this may optimize power savings for some VBI's, it may result in the display controller not receiving any or a sufficient portion of the first packet of pixels from memory by the start of some of the active periods (underflow).

The maximum power savings is obtained by powering off the display controller for the portion of the VBI that enables the housekeeping functions and the fetch of the first packet of pixels to complete right at, or right before, the start of the following active period. As the memory latency for each memory fetch may vary, the memory latency for the memory fetch associated with each VBI may be predicted. The predicted memory latency will be utilized to approximate the amount of time (the portion of the VBI) the display controller is powered off in order to maximum power savings for each VBI.

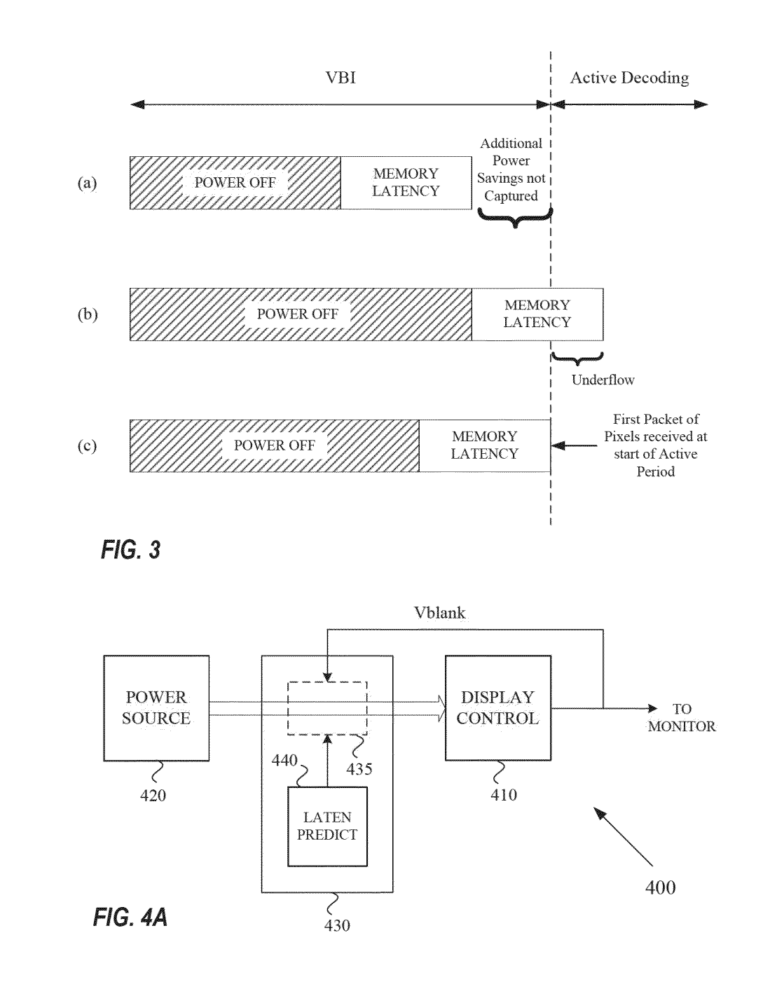

FIG. 3 illustrates several example timing diagrams of the display controller being powered off for different portions of the VBI. After the power is turned on, the display controller performs the housekeeping functions and fetches the first packet of pixels associated with a next frame from the memory. The housekeeping functions as well as the retrieve and put associated with the fetch are simply illustrated as memory latency (where the first packet of pixels for the next frame is available at the conclusion of the memory latency period). The memory latency is illustrated as being the same for each timing diagram.

Timing diagram (a) illustrates the powering off of the display controller not being optimized for power conservation. The first packet of pixels is received prior to the active period so that the display controller is idle for a period of time prior to the active period. The period of time between receiving the first packet of pixels and the active period reflects additional power savings that could have been captured but were not. Timing diagram (b) illustrates the powering off of the display controller resulting in an underflow condition. The first packet of pixels is received after the start of the active period. At the start of the active period, the display controller may start to output pixel values previously captured in the buffers for a previous frame before the first packet of pixels is received for the current frame which may result in visual artifacts and image corruption for the end user (corrupted frame). If an underflow occurs the current active writing period may be truncated, so the corrupted frame is not completely drawn, and then restarted so that the entire current frame can be drawn. Timing diagram (c) illustrates the powering off of the display controller being optimized for power conservation. The first packet of pixels is received right before, or right at, the start of the active period.

The memory latency may be predicted for each refresh cycle by various means. Each prediction may be based on measurements rather than previous predictions. Basing each prediction on measurements rather than previous estimates may ensure that any error margin in the predictions is not accumulated over time. The predicted memory latency for a VBI may be used to determine when to turn the power back on. According to one embodiment, the predicted memory latency may be subtracted from the amount of time associated with the VBI and the display controller may remain powered off for this time (power off time=VBI time−predicted memory latency).

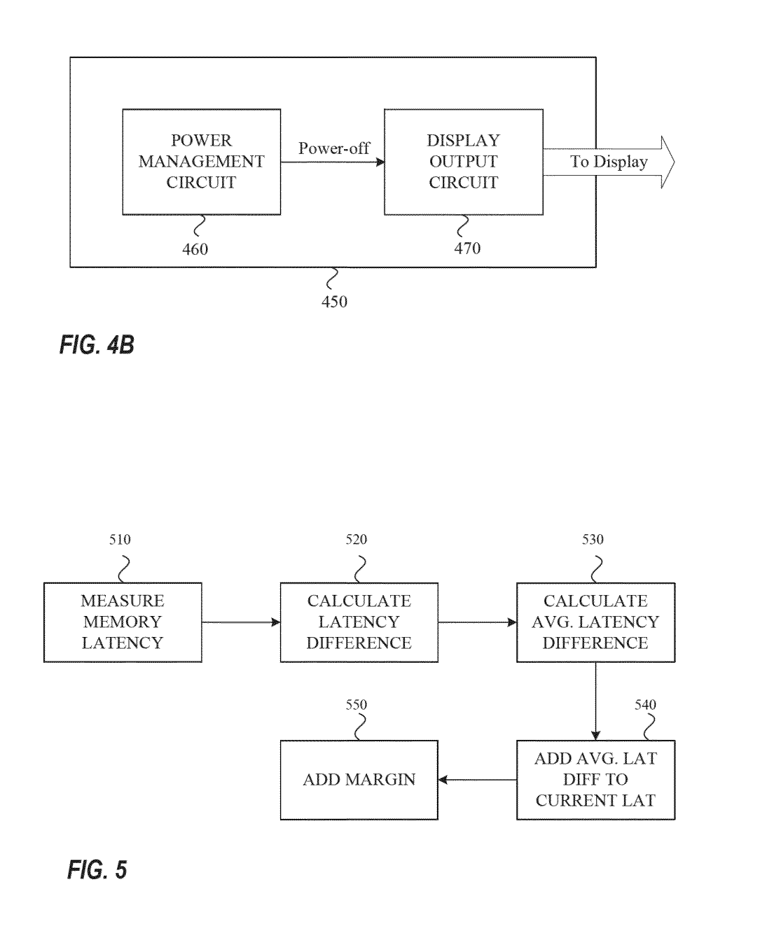

FIG. 4A illustrates an example functional block diagram of a system 400 for controlling the power state of a display controller 410. The system 400 includes the display controller 410 connected to a power source 420. A power management function 430 is included between the display controller 410 and the power source 420 to manage application of power to (the power state of) the display controller 410. The power management function 430 may include gating circuitry 435 and memory latency prediction functionality 440. The display controller 410 may send the vblank notification to the power management function 430 in order to activate the gating circuitry 435 (gate the power). The latency prediction functionality 440 may predict the memory latency and based thereon may determine the power on time and provide notification to the gating circuitry 435 to deactivate the gating of the power.

FIG. 4B illustrates an example functional block diagram of a display controller 450 capable of powering down during inactive periods. The display controller 450 includes a power management circuit 460 and a display output circuit 470. The power management circuit 460 determines when to power off the display output circuit 470 (what portion of each VBI). The display output circuit 470 receives frame information and generates the pixel data fur the display and outputs the data thereto.

According to one embodiment, the memory latency prediction may be based on the average latency over a certain number of previous memory fetches for the first packet of pixels for frames. For example, if the last five memory latency times for the first packets of pixels were 7 ms, 6 ms, 5 ms, 4 ms and 3 ms the average would be 5 ms. Additional time may be added to the average latency to account for the housekeeping overhead and as a margin of error for the latency prediction (may be programmable value). For example, an additional latency time of 2 ms (constant delay) may be added to the average latency to provide a predicted memory latency of 7 ms. The constant delay may be relatively small but provide for housekeeping overhead and limited tolerance in memory latency changes to avoid underflow conditions at cost of a small percentage of power savings. Using averages for predictions does not base the prediction on the current memory latency which may limit the accuracy of the prediction.

According to one embodiment, the latency prediction may linearly extrapolate a next memory latency from a current memory latency based on a certain number of previous memory latencies. The difference between consecutive memory latencies may be determined for the certain number of previous memory latencies. The differences may be averaged and the average difference may be added to the current latency. For example, utilizing the 7 ms, 6 ms, 5 ms. 4 ms and 3 ms times noted above the differences would be −1 ms, −1 ms, −1 ms and −1 ms so the average difference would be −1 ms. The average would be added to the current 3 ms memory latency to provide a 2 ms prediction. Constant delay (e.g., 2 ms) may be added to account for housekeeping overhead and as a margin so that prediction with constant delay added would be 4 ms. Comparing this linear extrapolation prediction to the average prediction shows that this prediction is likely to be more accurate as it takes the current memory latency and the trending thereof into account.

It should be noted that methods for predicting memory latency are in no way intended to be limited to those noted above. Various prediction methodologies, either simple or complex, may be utilized without departing from the current scope. Furthermore, while the examples noted above utilized actual times for the memory latency, the calculation and prediction of the memory latency is in no way intended to be limited thereby. For example, the memory latency may be measured by tracking how many clock cycles it takes to receive the data from the time of the request by using a clock-cycle based counter.

FIG. 5 illustrates an example high level flowchart for predicting the memory latency. Initially the memory latency is measured for memory fetches of the first packet of pixels for each frame 510. The difference between memory latency for successive first packet of pixels memory fetches is calculated 520, An average memory latency difference is calculated for a defined number of successive first packet of pixels memory fetches 530. The average memory latency difference is added to the current memory latency to linearly extrapolate the predicted memory latency for the memory fetch of the first packet of pixels for the next frame 540. A defined constant delay, taking into account housekeeping overhead and a margin of error, may be added to the predicted memory latency 550.

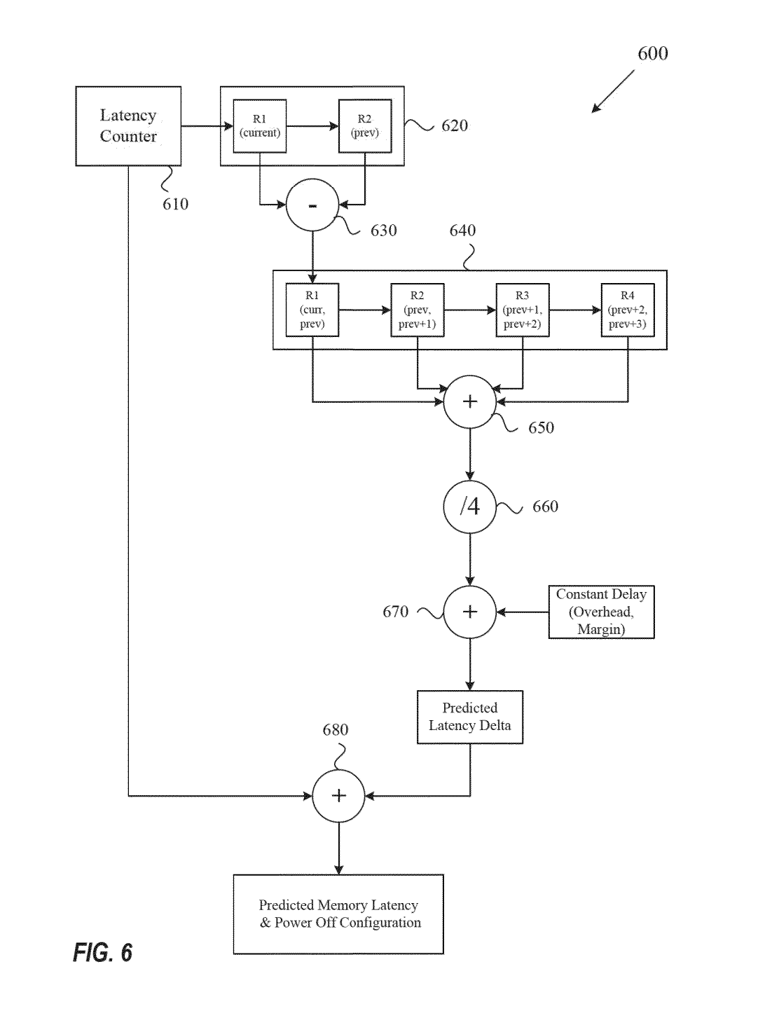

FIG. 6 illustrates an example memory latency predictor device 600. The device includes a latency counter 610, a first shift register 620, a subtracter 630, a second shift register 640, a first adder 650, a divider 660, a second adder 670 and a third adder 680. The latency counter 610 may be a clock-cycle based counter that counts the number of clock cycles that occur between a memory request for each first packet of pixels for a frame and the arrival thereof. The memory latency measurements (clock cycle counts) are stored in the first shift register 620. The first shift register 620 may be a two deep shift register for storing the previous latency measurement and the current latency measurement. The subtracter 630 calculates the difference between the previous and current latency measurements. The combination of the first shift register 620 and the subtracter 630 providing a difference calculator.

The latency Measurement differences are stored in the second shift register 640. The second shift register 640 may be a four deep register for storing the memory latency differences between each successive first packet of pixels memory fetch of the previous five first packet of pixels memory fetches. The latency measurement differences are averaged by summing the differences using the first adder 650 and then dividing the sum by 4 using a divider 660. The combination of the second shift register 640, the first adder 650, and the divider 660 providing a difference averager.

A constant delay (e.g., overhead, margin) may be added to the average latency difference using the second adder 670 to generate a predicted latency delta. The predicted latency difference is added to the current latency measurement using the third adder 680 to generate the next latency prediction. The third adder 680 and/or the second and third adders 670, 680 provide a memory latency predictor. The next latency prediction is used to predict the next power off period configuration (how long the power should be gated during the next VBI). While not illustrated, a power off predictor may predict the next power off period by subtracting the next latency prediction from the VBI period.

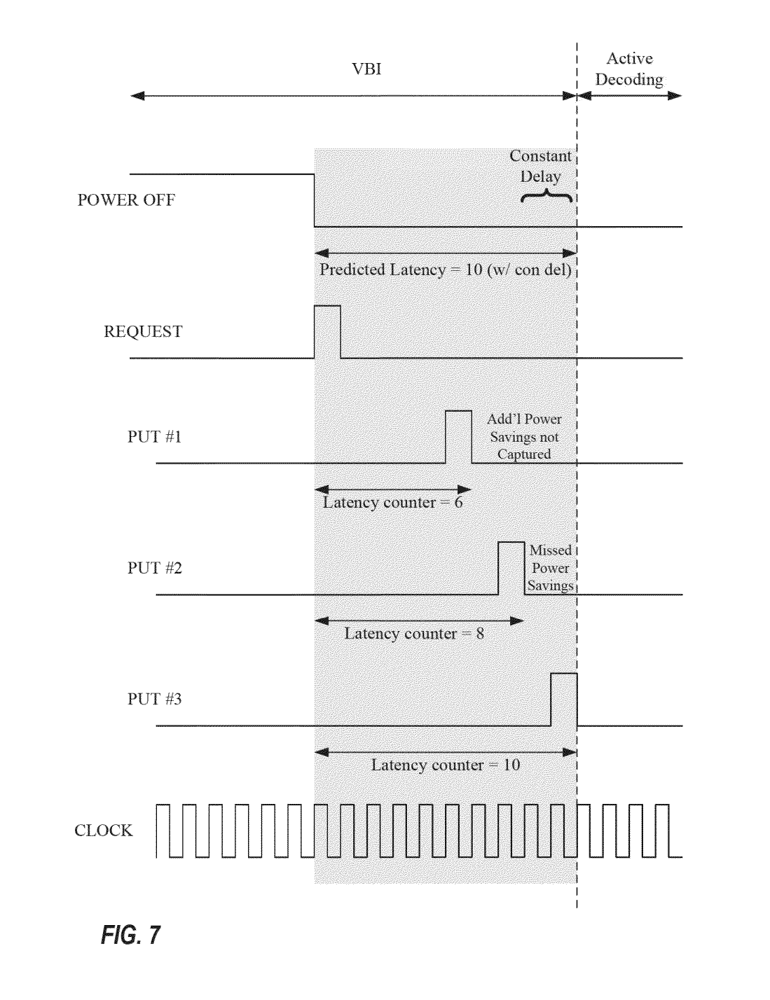

FIG. 7 illustrates several example timing diagrams of the display controller being powered off for a defined portion of the VBI based on the predicted memory latency. The latency is measured based on the number of clock cycles. The predicted memory latency including addition of a two clock cycle constant delay (overhead, margin) is 10 clock cycles. Accordingly, the power is turned back on 10 clock cycles prior to the end of the VBI/beginning of the next active period. Once the display controller is powered on it performs the housekeeping functions and requests a first packet of pixels for next frame from a frame buffer. Three example actual latencies are illustrated with respect to the predicted latency (less than, equal to, and greater than the predicted value excluding constant delay added thereto). It should be noted that the actual housekeeping function overhead is not illustrated; however it is considered to have occurred within the illustrated latencies before request and put of the first packet of pixels.

Put #1 illustrates the first packet of pixels being received from the memory after 6 clock cycles (memory latency of 6). The actual latency was two clock cycles less than the predicted value and 4 cycles less than the predicted value including constant delay added. As such, the display controller is idle for a period of 4 clock cycles prior to the actual start of the active period (missed 4 clock cycles of power savings). Put #2 illustrates the first packet of pixels being received from the memory after 8 clock cycles (memory latency of 8). The actual latency was the same as the predicted value and 2 cycles less than the predicted value including constant delay added. As such, the display controller is ready for an active period 2 clock cycles prior to the actual active period (missed 2 clock cycles of power savings). Put #3 illustrates the first packet of pixels being received from the memory after 10 clock cycles (memory latency of 10). The actual latency was 2 cycles greater than the predicted value and the same as the predicted value including constant delay added.

The addition of the constant delay reduced power savings in each of put #1 and put #2 by 2 clock cycles but avoided an underflow condition in put #3.

According to one embodiment, the display controller may perform the housekeeping functions and retrieve the first packet of pixels for a next frame at the start of a VBI and then may enter power off mode rather then generating the latency predictions described above. However, this embodiment would require that the buffers holding the first packet of pixels and registers maintaining memory address, line counters, pixel counters and the like to remain powered on in addition to the configuration registers. Maintaining power to these additional components of the display controller may reduce power sayings obtained.

The display controller power saving functionality described above in FIGS. 3-7 may be implemented, for example, in a CPU (e.g. 110 of FIG. 1), a display controller (e.g., 130 of FIG. 1), a graphics processor, an integrated circuit, circuitry or discrete components that are part of a computing platform, circuitry or discrete components that are part of a SoC, or some combination thereof. Furthermore, the operations may be implemented in hardware, software, firmware or some combination thereof. The CPU, graphics processor, and/or display controller may have access to device readable storage (on the device, off the device, or some combination thereof) that contains instructions that when executed by the device causes the device to perform at least a subset of the operations described above in FIGS. 3-7.

The various embodiments described above may be implemented in various systems that display content (content display systems) and the content display systems may be incorporated in various devices.

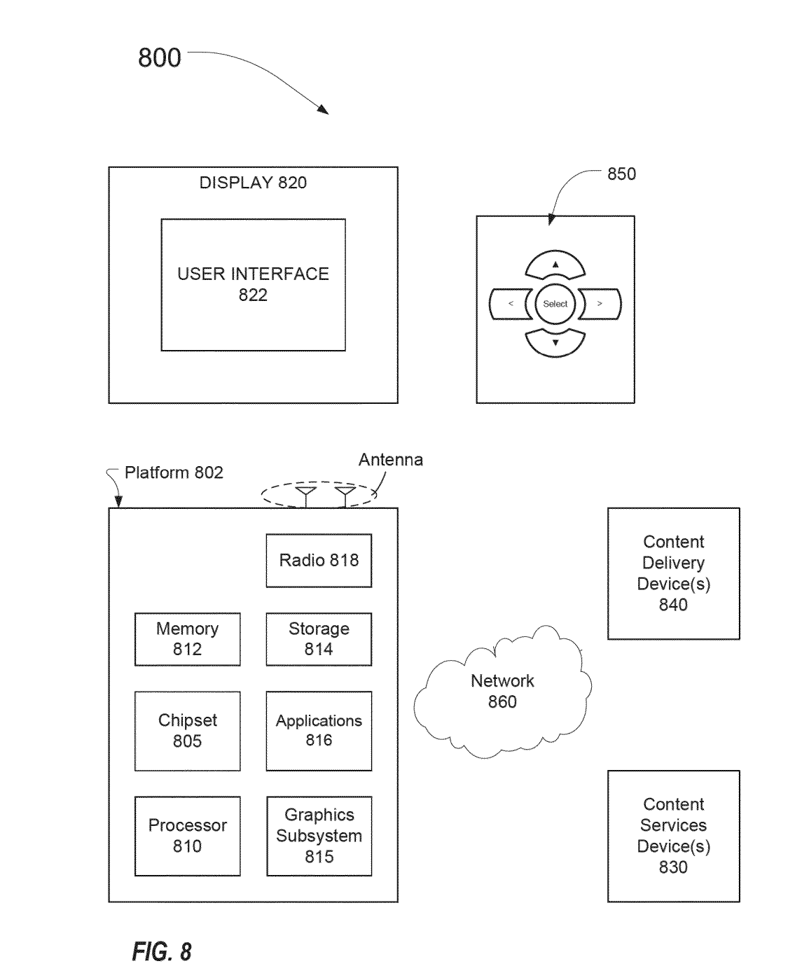

FIG. 8 illustrates an example content display system 800. The system 800 may be a media system although it is not limited to this context. The system 800 may be incorporated into, for example, a personal computer (PC), laptop computer, ultra-laptop computer, tablet, touch pad, portable computer, handheld computer, palmtop computer, personal digital assistant (PDA), cellular telephone, combination cellular telephone/PDA, television, smart device e.g., smart phone, smart tablet or smart television), mobile internet device (MID), messaging device, data communication device, and so forth.

In embodiments, the system 800 comprises a platform 802 coupled to an external display 820. The platform 802 may receive content from a content device such as content services device(s) 830, content delivery device(s) 840 or other similar content sources. A navigation controller 850 comprising one or more navigation features may be used to interact with, for example, the platform 902 and/or the display 820.

In embodiments, the platform 802 may comprise any combination of a chipset 805, a processor 810, memory 812, storage 814, a graphics subsystem 815, applications 816 and/or a radio 818. The chipset 805 may provide intercommunication among the processor 810, the memory 812, the storage 814, the graphics subsystem 815, the applications 816 and/or the radio 818. The chipset 805 may, for example, include a storage adapter (not depicted) capable of providing intercommunication with the storage 814.

The processor 810 may be implemented as Complex Instruction Set Computer (CISC) or Reduced Instruction Set Computer (RISC) processors, x86 instruction set compatible processors, multi-core, or any other microprocessor or central processing unit (CPU). In embodiments, the processor 810 may comprise dual-core processor(s), dual-core mobile processor(s), and so forth.

The memory 812 may be implemented as a volatile memory device such as, but not limited to, a Random Access Memory (RAM), Dynamic Random Access Memory (DRAM), or Static RAM (SRAM).

The storage 814 may be implemented as a non-volatile storage device such as, but not limited to, a magnetic disk drive, optical disk drive, tape chive, an internal storage device, an attached storage device, flash memory, battery backed-up SDRAM (synchronous DRAM) a network accessible storage device. In embodiments, the storage 814 may comprise technology to increase the storage performance or enhanced protection for valuable digital media when multiple hard drives are included, for example. The graphics subsystem 815 may perform processing of images such as still or video for display. The graphics subsystem 815 may be a graphics processing unit (GPU) or a visual processing unit (VPU), for example. An analog or digital interface may be used to communicatively couple the graphics subsystem 815 and the display 820. For example, the interface may be any of a High-Definition Multimedia Interface, DisplayPort, wireless HDMI, and/or wireless HD compliant techniques. The graphics subsystem 815 could be integrated into the processor 810 or the chipset 805. The graphics subsystem 815 could be a stand-alone card communicatively coupled to the chipset 805.

The graphics and/or video processing techniques described herein may be implemented in various hardware architectures. For example, graphics and/or video functionality may be integrated within a chipset. Alternatively, a discrete graphics and/or video processor may be used. As still another embodiment, the graphics and/or video functions may be implemented by a general purpose processor, including a multi-core processor. In a further embodiment, the functions may be implemented in a consumer electronics device.

The radio 818 may include one or more radios capable of transmitting and receiving signals using various suitable wireless communications techniques. Such techniques may involve communications across one or more wireless networks. Exemplary wireless networks include (but are not limited to) wireless local area networks (WLANs) wireless personal area networks (WPANs), wireless metropolitan area network (WMANs), cellular networks, and satellite networks. In communicating across such networks, the radio 818 may operate in accordance with one or more applicable standards in any version.

In embodiments, the display 820 may comprise any television type monitor or display. The display 820 may comprise, for example, a computer display screen, touch screen display, video monitor, television-like device, and/or a television. The display 820 may be digital and/or analog. In embodiments, the display 820 may be a holographic display. Also, the display 820 may be a transparent surface that may receive a visual projection. Such projections may convey various forms of information, images, and/or objects. For example, such projections may be a visual overlay for a mobile augmented reality (MAR) application. Under the control of one or more software applications 816, the platform 802 may display the user interface 822 on the display 820.

In embodiments, the content services device(s) 830 may be hosted by any national, international and/or independent service and thus accessible to the platform 802 via the Internet, for example. The content services device(s) 830 may be coupled to the platform 802 and/or to the display 820. The platform 802 and/or the content services device(s) 830 may be coupled to a network 860 to communicate (e.g., send and/or receive) media information to and from the network 860. The content delivery device(s) 840 also may be coupled to the platform 802 and/or to the display 820.

In embodiments, the content services device(s) 830 may comprise a cable television box, personal computer, network, telephone, Internet enabled devices or appliance capable of delivering digital information and/or content, and any other similar device capable of unidirectionally or bidirectionally communicating content between content providers and the platform 802 and/or the display 820, via the network 860 or directly. It will be appreciated that the content may be communicated unidirectionally and/or bidirectionally to and from any one of the components in the system 800 and a content provider via the network 860. Examples of content may include any media information including, for example, video, music, medical, gaming information, and so forth.

The content services device(s) 830 receives content such as cable television programming including media information, digital information, and/or other content. Examples of content providers may include any cable or satellite television or radio or Internet content providers. The provided examples are not meant to limit embodiments of the invention.

In embodiments, the platform 802 may receive control signals from navigation controller 850 having one or more navigation features. The navigation features of the controller 850 may be used to interact with the user interface 822, for example. In embodiments, the navigation controller 850 may be a pointing device that may be a computer hardware component (specifically human interface device) that allows a user to input spatial (e.g., continuous and multi-dimensional) data into a computer. Many systems such as graphical user interfaces (GUI), televisions and monitors allow the user to control and provide data to the computer or television using physical gestures.

Movements of the navigation features of the controller 850 may be echoed on a display (e.g., display 820) by movements of a pointer, cursor, focus ring, or other visual indicators displayed on the display. For example, under the control of software applications 816, the navigation features located on the navigation controller 850 may be mapped to virtual navigation features displayed on the user interface 822, for example. In embodiments, the controller 850 may not be a separate component but integrated into the platform 802 and/or the display 820. Embodiments, however, are not limited to the elements or in the context shown or described herein.

In embodiments, drivers (not shown) may comprise technology to enable users to instantly turn on and off the platform 802 like a television with the touch of a button after initial boot-up, when enabled, for example. Program logic may allow the platform 802 to stream content to media adaptors or other content services device(s) 830 or content delivery device(s) 840 when the platform is turned “off.” In addition, the chipset 805 may comprise hardware and/or software support for 5.1 surround sound audio and/or high definition 7.1 surround sound audio, for example. Drivers may include a graphics driver for integrated graphics platforms. In embodiments, the graphics driver may comprise a peripheral component interconnect (PCI) Express graphics card.

In various embodiments, any one or more of the components shown in the system 800 may be integrated. For example, the platform 802 and the content services device(s) 830 may be integrated, or the platform 802 and the content delivery device(s) 840 may be integrated, or the platform 802, the content services device(s) 830, and the content delivery device(s) 840 may be integrated, for example. In various embodiments, the platform 802 and the display 820 may be an integrated unit. In various embodiments, the display 829 and the content service device(s) 830 may be integrated, or the display 820 and the content delivery device(s) 840 may be integrated, for example. These examples are not meant to limit the invention.

In various embodiments, the system 800 may be implemented as a wireless system, a wired system, or a combination of both. When implemented as a wireless system, the system 800 may include components and interfaces suitable for communicating over a wireless shared media, such as one or more antennas, transmitters, receivers, transceivers, amplifiers, filters, control logic, and so forth. An example of wireless shared media may include portions of a wireless spectrum, such as the RF spectrum and so forth. When implemented as a wired system, the system 800 may include components and interfaces suitable for communicating over wired communications media, such as input/output (I/O) adapters, physical connectors to connect the I/O adapter with a corresponding wired communications medium, a network interface card (NIC), disc controller, video controller, audio controller, and so forth. Examples of wired communications media may include a wire, cable, metal leads, printed circuit board (PCB), backplane, switch fabric, semiconductor material, twisted-pair wire, co-axial cable, fiber optics, and so forth.

The platform 802 may establish one or more logical or physical channels to communicate information. The information may include media information and control information. Media information may refer to any data representing content meant for a user. Examples of content may include, for example, data from a voice conversation, videoconference, streaming video, electronic mail (“email”) message, voice mail message, alphanumeric symbols, graphics, image, video, text and so forth. Data from a voice conversation may be, for example, speech information, silence periods, background noise, comfort noise, tones and so forth. Control information may refer to any data representing commands, instructions or control words meant for an automated system. For example, control information may be used to route media information through a system, or instruct a node to process the media information in a predetermined manner. The embodiments, however, are not limited to the elements or in the context shown or described in FIG. 8.

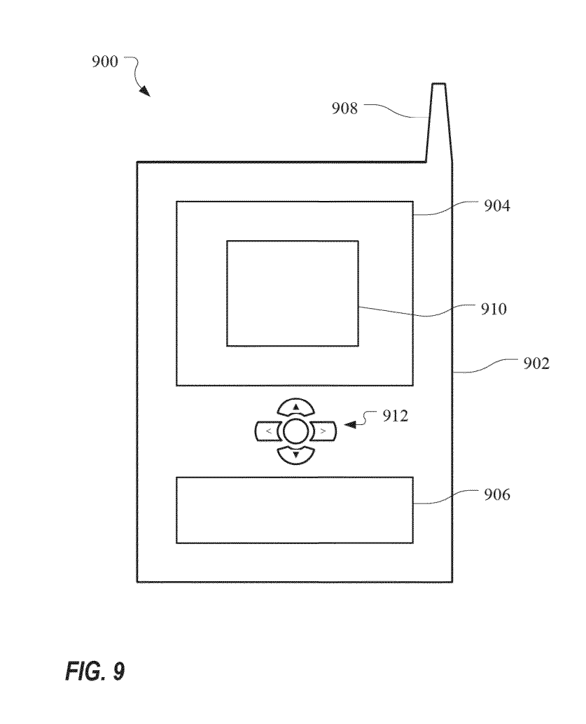

As described above, the system 800 may be embodied in varying physical styles or form factors. FIG. 9 illustrates embodiments of a small form factor device 900 in which the system 800 may be embodied. In embodiments, for example, the device 900 may be implemented as a mobile computing device having wireless capabilities. A mobile computing device may refer to any device having a processing system and a mobile power source or supply, such as one or more batteries, for example.

As described above, examples of a mobile computing device may include a personal computer (PC), laptop computer, ultra-laptop computer, tablet, touch pad,. portable computer, handheld computer, palmtop computer, personal digital assistant (PDA), cellular telephone, combination cellular telephone/PDA, television, smart device (e.g., smart phone, smart tablet or smart television), mobile interne device (MID), messaging device, data communication device, and so forth.

Examples of a mobile computing device also may include computers that are arranged to be worn by a person, such as a wrist computer, finger computer, ring computer, eyeglass computer, belt-clip computer, arm-band computer, shoe computers, clothing computers, and other wearable computers. In embodiments, for example the mobile computing device may be utilized in a vehicle (e.g., car, truck, van). The in-vehicle device may provide information and/or entertainment to occupants of the vehicle (in-vehicle infotainment (IVI) device). The IVI device may utilize power from the vehicle as an external power source in addition to or in place of an internal battery powering the device.

In embodiments, for example, a mobile computing device may be implemented as a smart phone capable of executing computer applications, as well as voice communications and/or data communications. Although some embodiments may be described With a mobile computing device implemented as a smart phone by way of example, it may be appreciated that other embodiments may be implemented using other wireless mobile computing devices as well. The embodiments are not limited in this context.

The device 900 may comprise a housing 902, a display 904, an input/output (I/O) device 906, and an antenna 908. The device 900 also may comprise navigation features 912. The display 904 may comprise any suitable display unit for displaying information appropriate for a mobile computing device. The I/O device 906 may comprise any suitable I/O device for entering information into a mobile computing device. Examples for the I/O device 906 may include an alphanumeric keyboard, a numeric keypad, a touch pad, input keys, buttons, switches, rocker switches, microphones, speakers, voice recognition device and software, and so forth. Information also may be entered into the device 900 by way of microphone. Such information may be digitized by a voice recognition device. The embodiments are not limited in this context. The device 900 may include a battery (not illustrated) to provide power thereto. The battery may be located in the device 900 (e.g., within the housing 902) and/or may be remote from the device 900 (e.g., vehicle battery utilized for IVI device).

Various embodiments may be implemented using hardware elements, software elements, or a combination of both. Examples of hardware elements may include processors, microprocessors, circuits, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), logic gates, registers, semiconductor device, chips, microchips, chipsets, and so forth. Examples of software may include software components, programs, applications, computer programs, application programs, system programs, machine programs, operating system software, middleware, firmware, software modules, routines, subroutines, functions, methods, procedures, software interfaces, application program interfaces (API), instruction sets, computing code, computer code, code segments, computer code segments, words, values, symbols, or any combination thereof. Determining whether an embodiment is implemented using hardware elements and/or software elements may vary in accordance with any number of factors, such as desired computational rate, power levels, heat tolerances, processing cycle budget, input data rates, output data rates, memory resources, data bus speeds and other design or performance constraints.

One or more aspects of at least one embodiment may be implemented by representative instructions stored on a machine-readable medium which represents various logic within the processor, which when read by a machine causes the machine to fabricate logic to perform the techniques described herein. Such representations, known as “IP cores” may be stored on a tangible, machine readable medium and supplied to various customers or manufacturing facilities to load into the fabrication machines that actually make the logic or processor.

Although the disclosure has been illustrated by reference to specific embodiments, it will be apparent that the disclosure is not limited thereto as various changes and modifications may be made thereto without departing from the scope. Reference to “one embodiment” or “an embodiment” means that a particular feature, structure or characteristic described therein is included in at least one embodiment. Thus, the appearances of the phrase “in one embodiment” or “in an embodiment” appearing in various places throughout the specification are not necessarily all referring to the same embodiment.

The various embodiments are intended to be protected broadly within the spirit and scope of the appended claims.

1. A display controller to have non-essential portions powered off for a portion of vertical blanking interval (VBI) periods to conserve power, wherein the portion takes into account overhead associated with housekeeping functions and memory latency associated with receiving a first packet of pixels for a frame to be decoded during a next active period.

2. The display controller of claim 1, wherein
the housekeeping functions include memory address calculations to determine where to fetch the next frame from and resetting counters, and
the memory latency is time between the display controller requesting the first packet of pixels from memory and receiving the first packet of pixels from the memory, wherein the memory latency may vary by VBI period.

3. The display controller of claim 2, wherein the memory latency is predicted per VBI period.

4. The display controller of claim 3, wherein the predicted memory latency for a next VBI period is based on average of actual memory latencies for receipt of the first packet of pixels for a plurality of VBI periods.

5. The display controller of claim 3, wherein the predicted memory latency for a next VBI period is based on average difference between successive actual memory latencies for receipt of the first packet of pixels for a plurality of VBI periods and actual memory latency for receipt of the first packet of pixels for previous VBI period.

6. The display controller of claim 2, wherein a constant delay is used to account for the housekeeping functions overhead.

7. The display controller of claim 1, wherein the portion is selected to enable completion of the housekeeping functions and the memory latency to finish in close proximity to the next active period.

8. An apparatus comprising
gating circuitry to control application of power to non-essential portions of a display controller, wherein the gating circuitry is to initiate gating of the power at start of vertical blanking interval (VBI) periods and maintain gating for a portion of the VBI periods to conserve power; and
a latency predictor to predict the portion of the VBI periods, wherein the prediction takes into account activities that need to be completed prior to a next active period, and wherein the activities include memory latency associated with receiving a first packet of pixels for a frame to be decoded during the next active period.

9. The apparatus of claim 8, wherein the latency predictor is to predict the portion by
predicting the memory latency for a next VBI period; and
subtracting the predicted memory latency from the VBI period.

10. The apparatus of claim 9, wherein the latency predictor is to predict the memory latency for the next VBI based on average of actual memory latencies for receipt for a plurality of VBI periods.

11. The apparatus of claim 9, wherein the latency predictor is to predict the memory latency for the next VBI period by adding an average difference between successive actual memory latencies for a plurality of VBI periods to an actual memory latency for previous VBI period.

12. The apparatus of claim 9, wherein the activities further include housekeeping functions, and wherein the latency predictor is to select a constant delay to account for the housekeeping functions overhead and subtract the constant delay as well as the predicted memory latency from the VBI period.

13. The apparatus of claim 12, wherein the latency predictor is to select the constant delay to include a margin of error for the memory latency prediction.

14. An apparatus comprising
a memory latency counter to count number of clock cycles that occur between a memory request for first packet of pixels for frames and the arrival thereof;
a difference calculator to calculate a difference between the number of clock cycles for successive frames;
an averager to determine an average difference for a plurality of frames;
a memory latency predictor to predict the memory latency for a next frame by adding the average difference to the number of clock cycles for a current frame;
a power off time predictor to predict portion of next VBI period power should be gated to a display controller based on the memory latency prediction for the next frame.

15. The apparatus of claim 14, wherein the memory latency predictor is further to add a constant delay to the number of clock cycles for the current frame.

16. The apparatus of claim 14, wherein the difference calculator includes a register and a substractor.

17. The apparatus of claim 14, wherein the averager includes a register, an adder and a divider.

18. The apparatus of claim 14, further comprising gating circuitry to gate the power to the display controller, wherein power is gated upon start of the VBI period and remains off for the predicted portion of the VBI period.

19. A mobile computing device comprising
a system on a chip (SoC) including
a processor;
memory;
a display controller;
gating circuitry to control application of power to non-essential portions of the display controller, wherein the gating circuitry is to initiate gating of the power at start of vertical blanking interval (VBI) periods and maintain gating for a portion of the VBI periods to conserve power; and
a latency predictor to predict the portion of the VBI periods, wherein the prediction takes into account memory latency associated with receiving a first packet of pixels for a frame to be decoded during a next active period;
a display;
a battery; and
an interface to a vehicle battery.

20. The mobile computing device of claim 19, wherein the latency predictor is to predict the portion by
predicting the memory latency for a next VBI period; and
subtracting the predicted memory latency from the VBI period.

21. The mobile computing device of claim 19, wherein the latency predictor is to predict the memory latency for the next VBI period by adding an average difference between successive actual memory latencies for a plurality of VBI periods to an actual memory latency for previous VBI period.

22. The mobile computing device of claim 19, wherein the latency predictor is further to predict the portion by subtracting a constant delay to account for housekeeping functions overhead and include a margin of error for the memory latency prediction.
